(19) United States
(12) Patent Application Publication
(10) Pub. No.: US 2017/0224017 A1
(43) Pub. Date: Aug. 10, 2017

(54) ELECTRONIC CIGARETTE

(71) Applicant: Shenzhen First Union Technology Co., Ltd., Shenzhen City (CN)

(72) Inventors: YONGHAI LI, Shenzhen City (CN); ZHONGLI XU, Shenzhen City (CN); LEXIANG DENG, Shenzhen City (CN); YINDENG DENG, Shenzhen City (CN); YUNPING ZHONG, Shenzhen City (CN)

(21) Appl. No.: 15/494,511

(22) Filed: Apr. 23, 2017

(30) Foreign Application Priority Data
Apr. 26, 2016 (CN) 201620360822.5

(51) Int. Cl. A24F 47/00; B65D 39/00; H05B 1/02

(52) U.S. Cl. CPC A24F 47/008; H05B 1/0244; B65D 39/0005; H05B 2203/021

(57) ABSTRACT

An exemplary electronic cigarette includes a housing, a mouthpiece arranged at a first end of the housing, a simulate cigarette end arranged at an opposite second end of the housing, a battery module received in the housing, a liquid cup arranged in the housing, and an atomizing unit arranged in the housing. The liquid cup is configured for containing tobacco liquid. The atomizing unit is electrically connected with the battery module, and configured for atomizing the tobacco liquid to form aerosol. The liquid cup includes a cup body and a resilient plug at an end of the cup body. The resilient plug is capable of being pierced by a needle of an injector, and capable of restoring to a sealed state after the needle of the injector is removed.

### TECHNICAL FIELD

The present invention relates to electronic cigarettes.

### BACKGROUND ART

To avoid liquid leakage of a typical disposable electronic cigarette during transportation and storage, tobacco liquid are filled in before selling or use. However, it is inconvenient for users to inject the tobacco liquid. Furthermore, the electronic cigarette may not be sealed properly after liquid injection, rendering liquid leakage.

What is needed, therefore, is an electronic cigarette, which can overcome the above shortcomings.

### SUMMARY

An exemplary electronic cigarette includes a housing, a mouthpiece arranged at a first end of the housing, a simulate cigarette end arranged at an opposite second end of the housing, a battery module received in the housing, a liquid cup arranged in the housing, and an atomizing unit arranged in the housing. The liquid cup is configured for containing tobacco liquid. The atomizing unit is electrically connected with the battery module, and configured for atomizing the tobacco liquid to form aerosol. The liquid cup includes a cup body and a resilient plug at an end of the cup body. The resilient plug is capable of being pierced by a needle of an injector, and capable of restoring to a sealed state after the needle of the injector is removed.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a side view of an electronic cigarette according to an exemplary embodiment.

FIG. 2 is a perspective exploded view of the electronic cigarette of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Several definitions that apply throughout this disclosure will now be presented.

The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

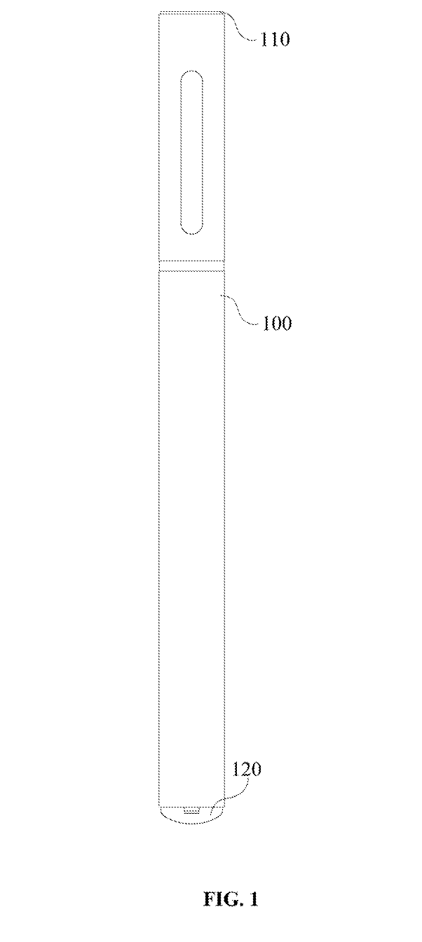

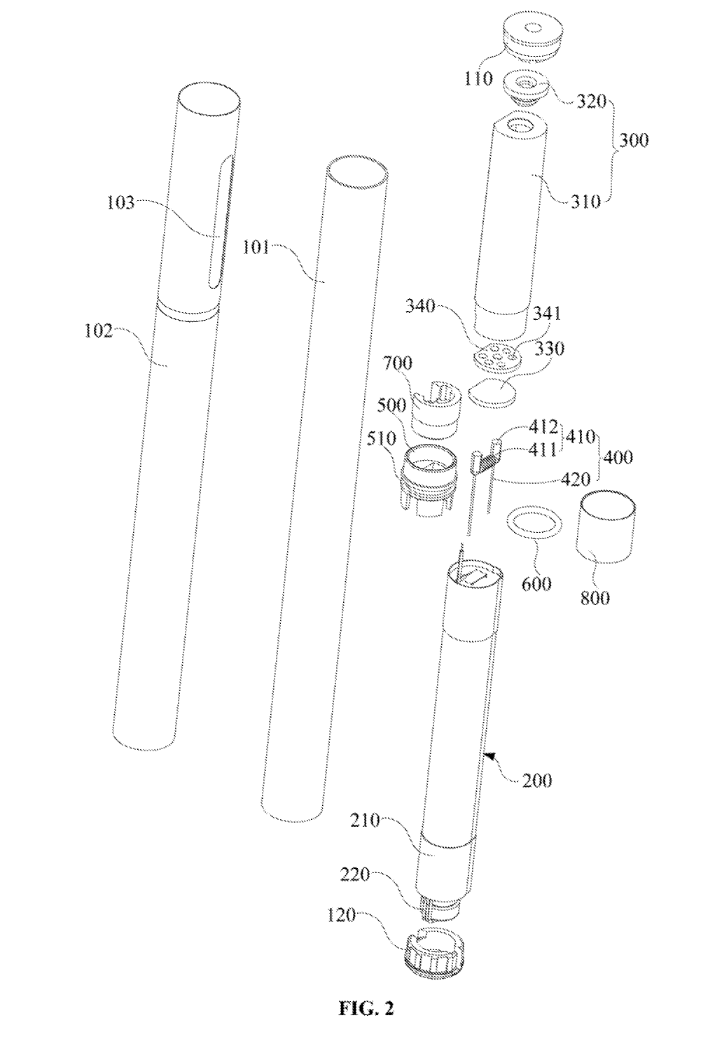

Referring to FIGS. 1 and 2, an electronic cigarette 10 is shown. The electronic cigarette 10 includes a housing 100, a battery module 200, a liquid cup 300, and an atomizing unit 400.

The housing 100 is cylindrical, one end of the housing 100 is provided with a mouthpiece 110, and the other end is provided with a simulate cigarette end 120. The simulate cigarette end 120 includes a light emitting element and a lampshade, and is configured for simulating burning of a traditional cigarette. In the present embodiment, the housing 100 includes an inner tube 101 and an outer tube 102. The inner tube 101 is light pervious, and the outer tube defines a window 103. Correspondingly, the liquid cup 300 is transparent. A total amount of the tobacco liquid in the liquid cup 300 can be seen through the window 103.

The battery module 200 is arranged in the housing 100. The battery module 200 includes a battery 210 and a controller 220 electrically connected with the battery 210. The controller 220 is configured (i.e., structured and arranged) for detecting a smoking signal, and activating the atomizing unit 400 and the stimulate cigarette end 120 in response to the smoking signal.

The liquid cup 300 is received in the housing 100, and is configured for containing tobacco liquid. The liquid cup 300 includes a cup body 310 and a resilient plug 320 arranged at an end of the cup body 310. The resilient plug 320 allows a needle of an injector (not shown) to pierce, so that tobacco liquid can be injected into the cup body 310. The resilient plug 320 will restore to a sealed state after the needle is pulled out. In the present embodiment, the resilient plug 320 is made of food-grade silicone.

In the present embodiment, the resilient plug 320 is arranged at an end of the cup body 310 facing the mouthpiece 110. The other end of the cup body 310 is provided with a liquid permeating layer 330. The liquid permeating layer 330 prevents the tobacco liquid in the cup body 310 from flowing out directly, and allows the tobacco liquid to permeate gradually. The liquid permeating layer 330 may be made of glass fiber, cotton, and so on.

The atomizing unit 400 is arranged in the housing 100, electrically connected with the battery module 200, and is configured for atomizing the tobacco liquid to form aerosol. The atomizing unit 400 includes a liquid conducting body 410 and a heating wire 420 wound around the liquid conducting body 410. The liquid conducting body 410 is configured for absorbing the tobacco liquid in the liquid cup 300 for atomization. In the present embodiment, the liquid conducting body 410 is made of glass fiber core. It is to be understood that in other embodiments, the liquid conducting body 410 may be made of porous ceramic or porous metal.

The liquid conducting body 410 is in contact with the liquid permeating layer 330, so that the liquid conducting body 410 can absorb tobacco liquid from the liquid permeating layer 330. Quite usefully, the liquid conducting body 410 is U-shaped, and includes a main body 411 and liquid absorbing parts 412 connected at two ends of the main body 411. The heating wire 420 is wound around the main body 411. The liquid absorbing parts 412 contact with the liquid permeating layer 330, and are substantially perpendicular to the liquid permeating layer 330.

Quite usefully, a cover body 340 is provided at the other end of the cup body 310. The cover body 340 is arranged on top of the liquid permeating layer 330. The cover body 340 defines a plurality of through holes 341 allowing the tobacco liquid to flow through to the liquid permeating layer 330.

In the present embodiment, the electronic cigarette 10 further includes a base holder 400, an O-shaped ring 600, a silicone holder 700, and a fixing tube 800. The base holder 500 is nested in the housing 100, and is arranged between the battery module 200 and the liquid cup 300. The base holder 500 defines an annular groove 510 in a side wall. The O-shaped ring 600 is made of resilient rubber, and is engaged in the annular groove 510. The O-shaped ring 600 is tightly engaged in an inner wall of the housing 100, thus avoiding liquid leakage, which may pollute the battery module 200. The silicone holder 700 is arranged on the base holder 500, and configured for supporting the liquid conducting body 410. The fixing tube 800 is configured for fixing the base holder 500 with a bottom part of the liquid cup 300.

Gaps are formed among the battery module 200, the liquid cup 300, the atomizing unit 400, and the housing 100, so that air incoming from the simulate cigarette end can flow to the mouthpiece 110. The silicone holder 700 defines a gap, and the aerosol generated by the atomizing unit 400 can be expelled via the gap. Further, the cup body 310 is substantially cylindrical, and includes a substantially flat sidewall. A gap is defined between the flat sidewall and the transparent sleeve 101. The gap serves as a passage, through which the aerosol flows to the mouthpiece 110.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An electronic cigarette, comprising:
a housing;
a mouthpiece arranged at a first end of the housing;
a simulate cigarette end arranged at an opposite second end of the housing;
a battery module received in the housing;
a liquid cup arranged in the housing, and being configured for containing tobacco liquid; and
an atomizing unit arranged in the housing, and electrically connected with the battery module, the atomizing unit being configured for atomizing the tobacco liquid to form aerosol;
wherein the liquid cup comprises a cup body and a resilient plug at an end of the cup body, the resilient plug is capable of being pierced by a needle of an injector, and capable of restoring to a sealed state after the needle of the injector is removed.

2. The electronic cigarette according to claim 1, wherein the resilient plug is arranged at a first end of the cup body facing the mouthpiece.

3. The electronic cigarette according to claim 1, wherein the atomizing unit includes a liquid conducting body and a heating wire wound around the liquid conducting body, the liquid conducting body is configured for absorbing the tobacco liquid for atomization, and the heating wire is configured for heating the tobacco liquid.

4. The electronic cigarette according to claim 3, further comprising a liquid permeating layer at an opposite second end of the cup body, wherein the liquid conducting body is in contact with the liquid permeating layer, so that the liquid conducting body absorbs the tobacco liquid from the liquid permeating layer.

5. The electronic cigarette according to claim 4, wherein the liquid permeating layer is made of cotton.

6. The electronic cigarette according to claim 4, wherein the liquid conducting body is U-shaped, includes a main body and two liquid absorbing parts connected at two ends of the main body, the heating wire is wound around the main body, and the liquid absorbing parts contact with the liquid permeating layer.

7. The electronic cigarette according to claim 6, further comprising a cover body at the opposite second end of the cup body, wherein the cover body is formed on top of the liquid permeating layer, and defines a plurality of through holes, so that the tobacco liquid in the liquid cup can flow to the liquid permeating layer.

8. The electronic cigarette according to claim 7, further comprising a base holder and an O-shaped ring, wherein the base holder is received in the housing, and arranged between the battery module and the liquid cup, the base holder defines an annular groove in a sidewall, and the O-shaped ring is engaged in the annular groove.

9. The electronic cigarette according to claim 8, further comprising a silicone holder arranged on the base holder, wherein the silicone holder is configured for supporting the liquid conducting body.

10. The electronic cigarette according to claim 1, wherein the housing comprises an inner tube and an outer tube, and the inner tube is light pervious, and the outer tube defines a window, through which a total amount of the tobacco liquid in the liquid cup can be seen.
